(19) United States
(12) Patent Application Publication
(10) Pub. No.: US 2016/0196109 A1
(43) Pub. Date: Jul. 7, 2016

(54) INTRINSICALLY SAFE REMOTE INTERACTION WITH COOKTOP

(71) Applicant: General Electric Company, Schenectady, NY (US)

(72) Inventor: Keith Wesley Wait, Louisville, KY (US)

(21) Appl. No.: 14/589,049

(22) Filed: Jan. 5, 2015

(51) Int. Cl. G06F 3/16; G05B 19/10; H05B 1/02

(52) U.S. Cl. CPC G06F 3/167; H05B 1/0266; G05B 19/102; G05B 2219/2643; G05B 2219/23386

(57) ABSTRACT

A cooktop appliance and a method for operating a cooktop appliance are provided. The cooktop appliance and the method include features for modifying the heating level of at least one heating element of the cooktop appliance and for indicating to a user of the cooktop appliance that the heating level has been modified.

### FIELD OF THE INVENTION

The subject matter of the present disclosure relates generally to methods and systems for remotely interacting with an appliance, in particular a cooktop appliance.

### BACKGROUND OF THE INVENTION

Cooktop appliances generally include one or more heating elements for cooking food items thereon. The heating elements may be turned on and the heating level of the heating elements set and modified by manipulation of one or more controls, including knobs, buttons, and the like, by a user of the cooktop appliance. However, while using one or more of the heating elements, the user may not be able to manipulate the controls to modify the heating level or turn off the one or more heating elements, e.g., if the user is engaged in another task and does not have a hand available to manipulate the controls. Therefore, hands-free or remote modification of the heating level is desirable.

Further, modification of a heating element's heating level both by remote means, such as with a voice command or the like, and local means, such as a knob, could cause confusion as to the current heating level of the heating element. For example, the user could set an initial heating level by turning a knob, with the position of the knob visually indicating to the user the heating level of the heating element. Then, the user could modify the heating level of the heating element by voicing a command to raise or lower the heating level, such that the knob continues to point to the initial, rather than the modified, heating level. Thus, features for indicating the current heating level of a cooktop's heating elements are also desirable.

Accordingly, an appliance having a cooktop with features for remotely modifying the heating level of heating elements of the cooktop and with features for indicating the heating level has been modified would be beneficial. A method for remotely modifying the heating level of heating elements of the cooktop and indicating the heating level has been modified also would be useful.

### BRIEF DESCRIPTION OF THE INVENTION

The present invention provides a cooktop appliance and for operation of a cooktop appliance. The cooktop appliance and the method include features for modifying the heating level of at least one heating element of the cooktop appliance and for indicating to a user of the cooktop appliance that the heating level has been modified. Additional aspects and advantages of the invention will be set forth in part in the following description, may be apparent from the description, or may be learned through practice of the invention.

In a first exemplary embodiment, a method for operating a cooktop appliance is provided. The cooktop appliance includes a cooktop having at least one heating element for heating food items. The method includes the steps of activating the heating element of the cooktop; storing a heating level of the heating element; determining whether an input to modify the heating level has been received and, if so, then modifying the heating level; storing the modified heating level; indicating to a user of the cooktop that the heating level has been modified.

In a second exemplary embodiment, a cooktop appliance is provided. The cooktop appliance includes a cooktop having at least one heating element; a control for controlling a heating level of the heating element; an indicator for indicating the heating level of the heating element; and a controller in operative communication with the heating element and the indicator. The controller is configured for activating the heating element; storing the heating level of the heating element; determining whether an input to modify the heating level has been received and, if so, then modifying the heating level; storing the modified heating level; and indicating to a user of the cooktop appliance that the heating level has been modified.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an oven range appliance received within a set of kitchen cabinets according to an exemplary embodiment of the present subject matter.

FIG. 2 provides a front view of a knob and an indicator according to an exemplary embodiment of the present subject matter.

FIG. 3 provides a chart illustrating an exemplary method for operating an oven range appliance according to the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

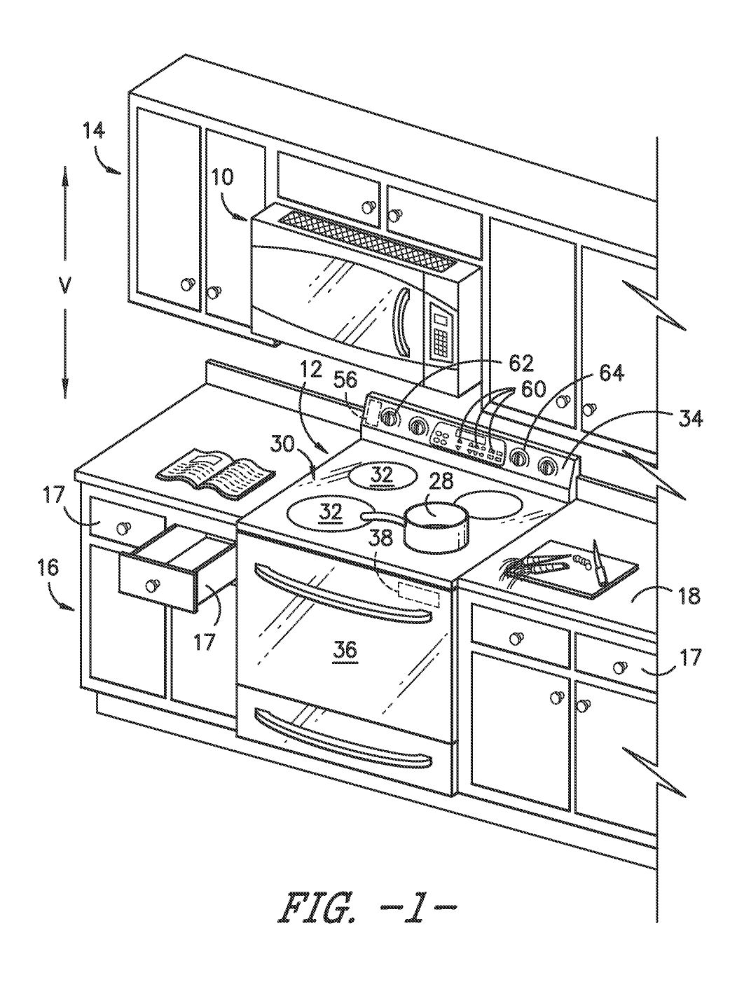

FIG. 1 provides a perspective view of an oven range appliance 12 having a cooktop 30 received within a set of kitchen cabinets. Oven range appliance 12 is provided by way of example only and is not intended to limit the present subject matter in any aspect. Thus, the present subject matter may be used with other cooktop appliance configurations, e.g., cooktop appliances having only a cooktop or oven range appliances that define one or more interior cavities for the receipt of food. Further, the present subject matter may be used in any other suitable appliance.

FIG. 1 also illustrates a microwave appliance 10, commonly referred to as an over-the-range microwave, mounted to an upper set of kitchen cabinets 14 above an oven range appliance 12, e.g., along a vertical direction V. Upper set of kitchen cabinets 14 is positioned above a base set of kitchen cabinets 16, e.g., along the vertical direction V. Base set of kitchen cabinets 16 includes countertops 18 and drawers 17. Oven range appliance 12 is received within base set of kitchen cabinets 16 below microwave appliance 10 such that cooktop 30 of oven range appliance 12 is positioned, e.g., directly below microwave appliance 10 along the vertical direction V. Microwave appliance 10 can include features such as an air handler or fan (not shown) that can draw cooking vapors and/or smoke away from cooktop 30 and out of the kitchen containing microwave and oven range appliances 10 and 12.

Cooktop 30 of range 12 includes a plurality of heating elements 32, e.g., electrical resistive heating elements, gas burners, induction heating elements, and/or any other suitable heating element or combination of heating elements. Cooking utensils, such as cooking utensil 28, may be placed on heating elements 32 to cook or heat food items. Oven range appliance 12 also includes a door 36 that permits access to a cooking chamber (not shown) of oven range appliance 12, e.g., for cooking or baking of food items therein. Further, oven range appliance 12 includes a door lock 38 that, when engaged, prevents door 36 from opening. Door lock 38 may be an electromechanical lock or any other suitable locking device.

A control panel 34 of oven range appliance 12 having a variety of controls 60, including knobs 62, can permit a user to make selections for cooking of food items on cooktop 30 or within the cooking chamber, e.g., a heating level of a heating element 32, a duration of a cooking cycle of the cooking chamber, and/or a power setting for the cooking cycle of the cooking chamber. As shown, in addition to knobs 62, controls 60 of control panel 34 may include various input components, such as one or more of a variety of electrical, mechanical, or electro-mechanical input devices including rotary dials, push buttons, and touch pads. Panel 34 also may include various display components, such as digital and/or analog display devices designed to provide operational or other feedback to a user.

In particular, control panel 34 may include one or more indicators 70 for indicating a heating level of each heating element 32, i.e., one or more indicators 70 may be associated with a particular heating element 32 to indicate the heating level of the heating element. The heating level effectively is the amount of power provided to the heating element, which is converted to heat that is provided to a cooking utensil or food item placed on the heating element. A user may set or modify by, e.g., turning knob 62 clockwise or counter-clockwise, manipulating one or more controls 60, and/or remotely giving one or more commands, as further described below. The heating level typically is designated by descriptors such as, e.g., low, medium-low, medium, medium-high, and high. That is, when the heating level of a heating element 32 is set as low, the heating element provides the least amount of heat, and when the heating level is set as high, the heating element provides the most amount of heat. Alternatively, the heating level may be any level between 0 and 100 percent of the heat heating element 32 can provide. Indicator 70 may indicate the heating level of heating element 32, as further described below.

The operation of oven appliance 12, including cooktop 30 and heating elements 32, is controlled by a processing device such as a controller 56, which may include a microprocessor or other device that is in communication with such components. Controller 56 is operatively coupled or in communication with various other components of oven range appliance 12, including controls 60, 62, indicators 70, and door lock 38. In response to user manipulation of controls 60, 62 controller 56 operates the various components of oven range appliance 12 to execute selected cycles and features.

Controller 56 may include a memory and microprocessor, such as a general or special purpose microprocessor operable to execute programming instructions or micro-control code associated with a cleaning cycle. The memory may represent random access memory such as DRAM, and/or read only memory such as ROM or FLASH. In one embodiment, the processor executes programming instructions stored in memory. The memory may be a separate component from the processor or may be included onboard within the processor. Alternatively, controller 56 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 60, 62 and other components of oven range appliance 12 may be in communication with controller 56 via one or more signal lines or shared communication busses.

Controller 56 may activate, initiate, modify, or execute certain features of oven range appliance 12 in response to local and remote inputs by a user of the appliance. For example, controller 56 may be configured to detect as remote inputs voice commands of a user of the oven range appliance and to utilize the inputs, e.g., to modify operations of cooktop 30. Such commands may include “Set Burner One to medium-low” or “Turner off Burner Two,” where Burner One and Burner Two denote particular heating elements 32. The voice commands may be authenticated, i.e., distinguished from attempts by a child operate oven range appliance 12, and/or confirmed through the use of a unique spoken phrase. The unique phrase may be any phrase chosen by the user and programmed into, e.g., controller 56, and multiple users may each have a unique programmed phrase. Alternatively, the voice commands may be authenticated and/or confirmed through the use of voice biometrics, which may distinguish an adult voice from a juvenile voice, identify an exact voice, or otherwise authenticate commands such that only adults or specific persons may initiate or cancel operations of oven range appliance 12. Further, the voice commands may be detected and utilized by controller 56 in whole or in part. In other embodiments, the voice commands may be detected and utilized by any combination of, e.g., a stand-alone or embedded microphone, a smartphone, a tablet computer, and a cloud computing system. Other devices may also be used to detect and utilize a user's voice commands.

As a further example, controller 56 may be configured to detect, as remote inputs, gestures of a user, e.g., through Swept Frequency Capacitive Sensing (SFCS), or controller 56 may be enabled with wireless communication components (e.g., “Wi-Fi”) to detect user inputs through another wireless communication enabled device such as, e.g., a cellular phone, tablet computer, or the like. Other forms of communication, such as a wired connection, may be used, as well as other types of remote inputs and means of detecting remote inputs. Controller 56 can also be provided with other features as will be further described herein.

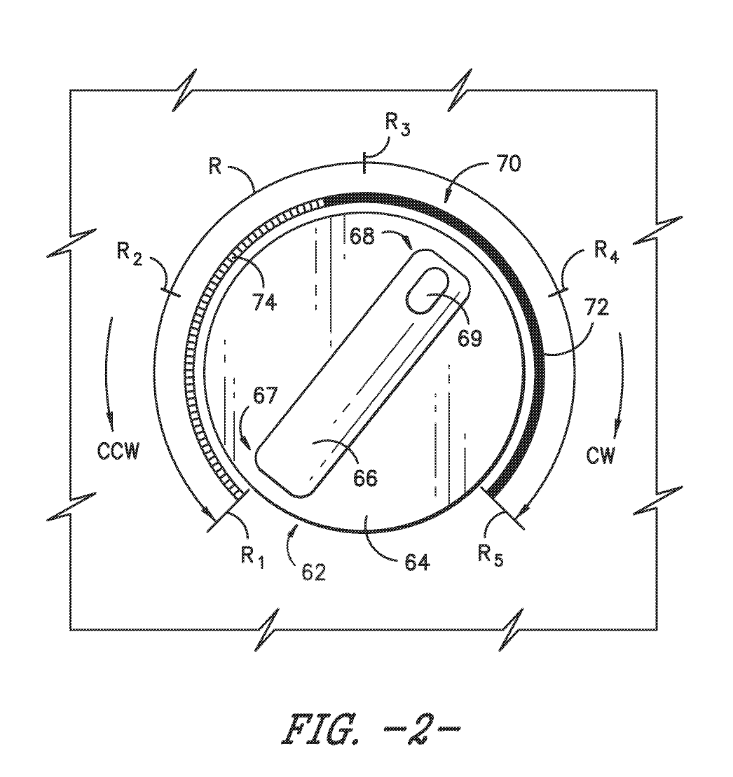

FIG. 2 illustrates a knob 62 and an indicator 70 according to an exemplary embodiment of the present subject matter. A knob and indicator combination may be provided for each heating element 32 (FIG. 1). As shown in the exemplary embodiment of FIG. 2, knob 62 includes a body portion 64 and a gripping portion 66 having opposing ends 67, 68. A user may grip gripping portion 66 to rotate knob 62 in a clockwise direction CW or in a counter-clockwise direction CCW to, e.g., activate the associated heating element 32 and/or locally modify the heating level of the heating element. As shown, knob 62 may have a range of motion R over which knob 62 rotates to change the heating level of heating element 32. That is, when heating element 32 is activated and end 68 of gripping portion 66 is located at position R₁ of range of motion R, the heating level of heating element 32 is set at the minimum heating level of heating element 32, e.g., the low heating level. When end 68 is located at position R₅ of range of motion R while heating element 32 is activated, the heating level of heating element 32 is set at the maximum heating level of the heating element, e.g., the high heating level. Thus, a user may rotate knob 62 over range of motion R to vary the heating level of heating element 32 between its minimum and maximum. Text, digits, and/or graphics may be included on, e.g., control panel 34 adjacent knob 62 to label various locations along range of motion R with the corresponding heating level of the heating element 32. For example, position R₂ may correspond to the medium-low setting, position R₃ may correspond to the medium setting, and position R₄ may correspond to the medium-high setting, and these positions, as well as positions R₁ and R₅, may be labeled accordingly.

End 68 of gripping portion 66 may include an indicator portion 69 to denote the heating level of an associated heating element 32, i.e., indicator portion 69 points out the position of end 68 relative to range of motion R. Indicator portion 69 may be, e.g., an illuminable area, a label, or other marking sufficient to indicate end 68 of gripping portion 66 denotes the heating level of the heating element 32 associated with knob 62. In some embodiments, indicator portion 69 may also signify that an associated heating element 32 is activated. For example, indicator portion 69 may be an illuminable area that is illuminated when a heating element 32 associated with knob 62 is activated. Other configurations of knob 62 may be used as well.

As further illustrate in FIG. 2, indicator 70 includes an illuminable portion 72 that may be illuminated by a light source (not shown) such as, e.g., one or more light emitting diodes (LEDs) or any other appropriate light source positioned in a suitable location to illuminate illuminable portion 72, such as within control panel 34. Illuminable portion 72 of indicator 70 is co-extensive with range of motion R of knob 62, extending from R₁ to R₅. Accordingly, controller 56 may be configured to illuminate illuminable portion 72 to indicate the heating level of the corresponding heating element 32, e.g., by activating the light source. The smallest portion of illuminable portion 72 is illuminated to indicate heating element 32 is set at its minimum heating level, and all of illuminable portion 72 is illuminated to indicate heating element 32 is set at its minimum heating level. An illuminated portion between the smallest portion and the total portion of illuminable portion 72 would indicate the heating level was set between its minimum and maximum values. For example, indicator 70 of FIG. 2 has an illuminated area 74 extending from R₁ to almost R₃, indicating the heating level of the associated heating element 32 is just under the medium heating level, i.e., just less than half of the maximum heating level, or approximately 40 to 45 percent. Additionally, no portion of illuminable portion 72 may be illuminated if heating element 32 is not activated. Thus, indicator 70 may indicate to a user of cooktop 30 whether the associated heating element 32 is activated and, if so, the heating level at which heating element 32 is set. Other configurations of indicator 70 also may be used.

Moreover, indicator 70 indicates the heating level of heating element 32 independent of knob 62. That is, if a user activates heating element 32 and sets an initial heating level using knob 62 and then the user modifies the heating level of heating element 32 through a remote input as described above, indicator 70 can display the heating level of heating element 32 as remotely modified by the user. Accordingly, as shown in FIG. 2, indicator 70 may indicate the current heating level of heating element 32, which may be a different heating level than the heating level indicated by knob 62.

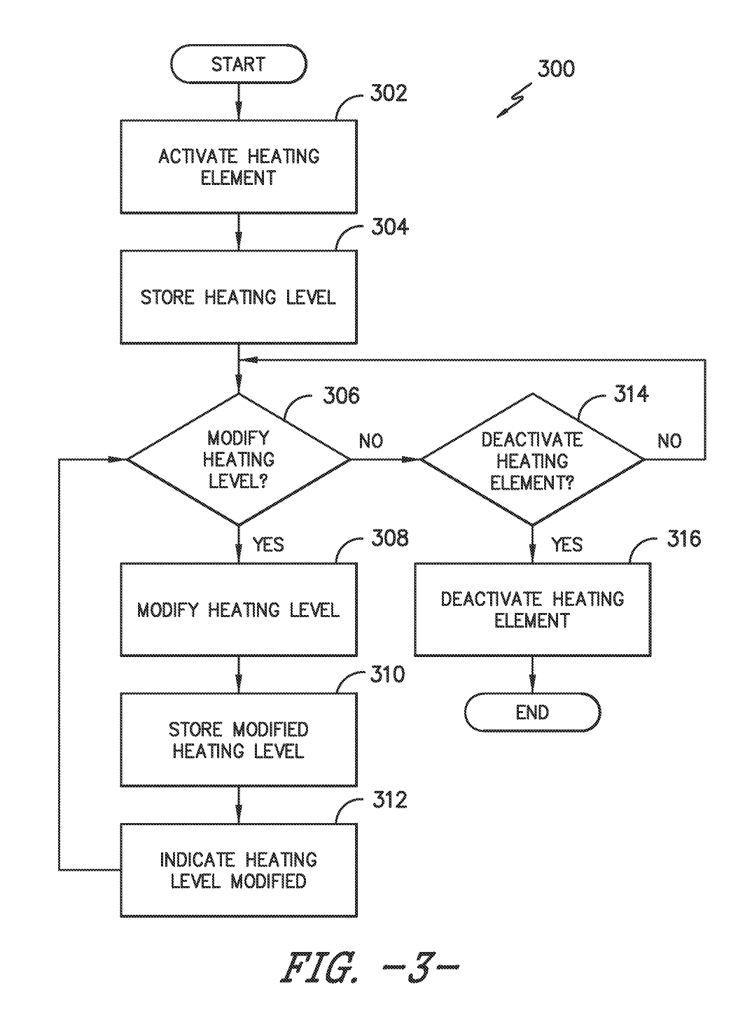

Referring now to FIG. 3, an exemplary method for operating cooktop 30 of oven range appliance 12 is illustrated. Although described below as largely performed by controller 56, method 300 may be performed in whole or in part by controller 56 or any other suitable device or devices. At step 302, a heating element 32 is activated. Heating element 32 may be activated in response to two simultaneous inputs by the user, e.g., pushing down or in on knob 62 associated with heating element 32 while simultaneously rotating knob 62 to set an initial heating level of heating element 32. Requiring two simultaneous user inputs to activate heating element 32 generally increases the safety of cooktop 30, for example, by preventing activation of heating element 32 in response to an accidental manipulation of controls 60, 62 by a user, another person, or a pet. Heating element 32 may be activated in other ways as well.

At step 304, controller 56 stores the initial heating level of heating element 32 selected by the user, e.g., by rotating knob 62 as described. Thereafter, as shown at step 306, controller 56 determines whether an input to modify the heating level of heating element 32 has been received. The input to modify the heating level may be a remote input, such as a voice or gesture command or an input transmitted by a wireless device as described above, or manipulation of one or more controls 60 or knob 62. Thus, at step 306, controller 56 detects whether such input has been received by controller 56. As an example, if heating element 32 activated at step 302 is the heating element designated as Burner One and the initial heating level stored at step 304 is the medium-high heating level, a user may voice the command “Set Burner One to medium-low,” which may be detected by controller 56 as an input to modify the heating level of heating element 32. Other ways of determining whether an input to modify the heating level has been received also may be used.

If, at step 306, controller 56 determines an input to modify the heating level has been received, controller 56 modifies the heating level at step 308 based on the received input. Continuing with the above example, if the user voices the command “Set Burner One to medium-low” and heating element 32 is the heating element designated Burner One, at step 308 the heating level of heating element 32 is modified such that the heating level is set to medium-low. Then, at step 310, the modified heating level is stored as the heating level of heating element 32. In the foregoing example, the heating level would be stored as medium-low.

Method 300 may also include step 312 of indicating to the user that the heating level has been modified. The modified heating level may be indicated using, e.g., indicator 70 as described above. Alternatively, step 312 may include utilizing any audible and/or visual signal, such as, e.g., a textual and/or graphic indication displayed on control panel 34 or a buzzer, that indicates to the user that the heating level of heating element 32 has been modified. For the foregoing example, at step 312, illuminable portion 72 of indicator 70 may be illuminated to indicate the heating level of heating element 32 has been modified to a medium-low heating level, e.g., illuminated area 74 may extend from approximately position R₁ to approximately position R₂.

However, if at step 306 controller 56 determines an input to modify the heating level has not been received, method 300 may include step 314 of determining whether an input to deactivate heating element 32 has been received. If not, controller 56 continues to determine whether an input to modify the heating level has been received. If an input to deactivated heating element 32 has been received, heating element 32 is deactivated at step 316. The input to deactivate heating element 32 may be a remote input, such as a voice or gesture command or an input transmitted by a wireless device as described above, or manipulation of one or more controls 60 or knob 62. Thus, at step 314, controller 56 detects whether such input has been received by controller 56. For example, if heating element 32 activated at step 302 is the heating element designated as Burner One, the user may voice the command “Turn off Burner One,” which may be detected by controller 56 as an input to deactivate heating element 32. Other ways of determining whether an input to deactivate heating element 32 has been received may be used as well.

Controller 56 may be programmed to execute method 300 with respect to each heating element 32 of cooktop 30. That is, controller 56 may be configured such that the heating level of each heating element 32 of cooktop 30 may be modified based on a local or remote input and the modified heating level indicated to the user. Controller 56 may be further configured such that each heating element 32 may be deactivated based on a local or remote input. In this way, use of cooktop 30 is more convenient, as the user is not required to be at cooktop 30 or able to touch cooktop 30 to modify the heating level of any heating element 32 or to deactivate any heating element 32.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method of operating a cooktop appliance, the cooktop appliance including a cooktop having at least one heating element for heating food items, the method comprising the steps of:
activating the heating element of the cooktop;
storing a heating level of the heating element;
determining whether an input to modify the heating level has been received and, if so, then
modifying the heating level;
storing the modified heating level;
indicating to a user of the cooktop appliance that the heating level has been modified.

2. The method of claim 1, wherein the method returns to the step of determining at the step of indicating.

3. The method of claim 1, wherein the input to modify the heating level is a voice command from the user of the cooktop appliance.

4. The method of claim 3, wherein the step of determining comprises detecting whether the user has given the voice command to modify the heating level of the heating element.

5. The method of claim 1, further comprising, if an input to modify the heating level has not been received at the step of determining, the steps of:
determining whether an input to deactivate the heating element has been received and, if so, then
deactivating the heating element.

6. The method of claim 5, wherein the input to deactivate the heating element is a voice command from the user of the cooktop appliance.

7. The method of claim 1, wherein the step of indicating comprises illuminating an indicator to indicate the heating level of the heating element has been modified.

8. A cooktop appliance, comprising:
a cooktop having at least one heating element;
a control for controlling a heating level of the heating element;
an indicator for indicating the heating level of the heating element; and
a controller in operative communication with the heating element and the indicator, the controller configured for
activating the heating element;
storing the heating level of the heating element;
determining whether an input to modify the heating level has been received and, if so, then
modifying the heating level;
storing the modified heating level; and
indicating to a user of the cooktop appliance that the heating level has been modified.

9. The cooktop appliance of claim 8, wherein the indicator is positioned adjacent the control for the heating element.

10. The cooktop appliance of claim 8, wherein the indicator comprises an illuminable portion for indicating the heating level of the heating element.

11. The cooktop appliance of claim 8, wherein the control comprises a rotatable knob and the indicator comprises an illuminable portion positioned adjacent the knob, the illuminable portion co-extensive with a range of motion of the knob over which the heating level of the heating element may be changed by rotating the knob.

12. The cooktop appliance of claim 8, wherein the cooktop appliance comprises a plurality of heating elements, each heating element having a control and an indicator, and wherein the controller is in operative communication with each heating element and indicator.

13. The cooktop appliance of claim 12, wherein the controller is further configured for
activating a particular heating element of the plurality of heating elements in response to an input to activate the particular heating element;
storing the heating level of the particular heating element;
determining whether an input to modify the heating level of the particular heating element has been received and, if so, then
modifying the heating level of the particular heating element;
storing the modified heating level; and
indicating to a user of the cooktop appliance that the heating level has been modified.

14. The cooktop appliance of claim 8, wherein the controller is further configured for returning to the step of determining at the step of indicating.

15. The cooktop appliance of claim 8, wherein the input to modify the heating level is a voice command from the user of the cooktop appliance.

16. The cooktop appliance of claim 15, wherein controller is configured for detecting, at the step of determining, whether the user has given the voice command to modify the heating level of the heating element.

17. The cooktop appliance of claim 8, wherein the controller is further configured for, if an input to modify the heating level has not been received at the step of determining:
determining whether an input to deactivate the heating element has been received and, if so, then
deactivating the heating element.

18. The cooktop appliance of claim 17, wherein the input to deactivate the heating element is a voice command from the user of the cooktop appliance.

19. The cooktop appliance of claim 8, wherein the controller is configured for illuminating the indicator to indicate the heating level of the heating element has been modified.
